(19) United States
(12) Patent Application Publication
(10) Pub. No.: US 2006/0146789 A1
(43) Pub. Date: Jul. 6, 2006

(54) Method and apparatus for enabling personalized name identification in the calling name field

(76) Inventors: Marian Croak, Fair Haven, NJ (US); Hossein Eslambolchi, Los Altos Hills, CA (US)

Correspondence Address: Mr. S.H. Dworetsky;AT&T Corp., Room 2A-207, One AT&T Way, Bedminster, NJ, 07921, US

(21) Appl. No.: 11/017,998

(22) Filed: Dec. 21, 2004

(51) Int. Cl. H04M 15/06; H04M 1/56

(52) U.S. Cl. 370/352; 379/142.01

(57) ABSTRACT

The present invention enables registered subscribers to register their preferred identity or name with a VoIP network service. This registered name will then be forwarded in the calling name field of the call setup message when these users signal to the network that they want to place a call to another network user.

The present invention relates generally to communication networks and, more particularly, to a method and apparatus for enabling personalized name identification in the call name field in packet-switched network services, e.g., Voice over Internet Protocol (VoIP) services.

### BACKGROUND OF THE INVENTION

As VoIP services grow, users of VoIP networks will communicate with other users of the VoIP network. Unlike users of instant messaging, the VoIP network users are unable to use a personalized name or identity when communicating with other users.

Therefore, a need exists for a method and apparatus for enabling personalized name identification in the calling name field in packet-switched network services, e.g., Voice over Internet Protocol (VoIP) services.

### SUMMARY OF THE INVENTION

In one embodiment, the present invention enables registered VoIP subscribers to register their preferred identity or name with a packet-switched network service, e.g., a VoIP network service. This registered name will then be forwarded in the calling name field of the call setup message when these users signal to the network that they want to place a call to another network user.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of enabling personalized name identification in the calling name field in VoIP services of the present invention;

FIG. 3 illustrates a flowchart of a method for enabling personalized name identification in the calling name field in VoIP services of the present invention; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

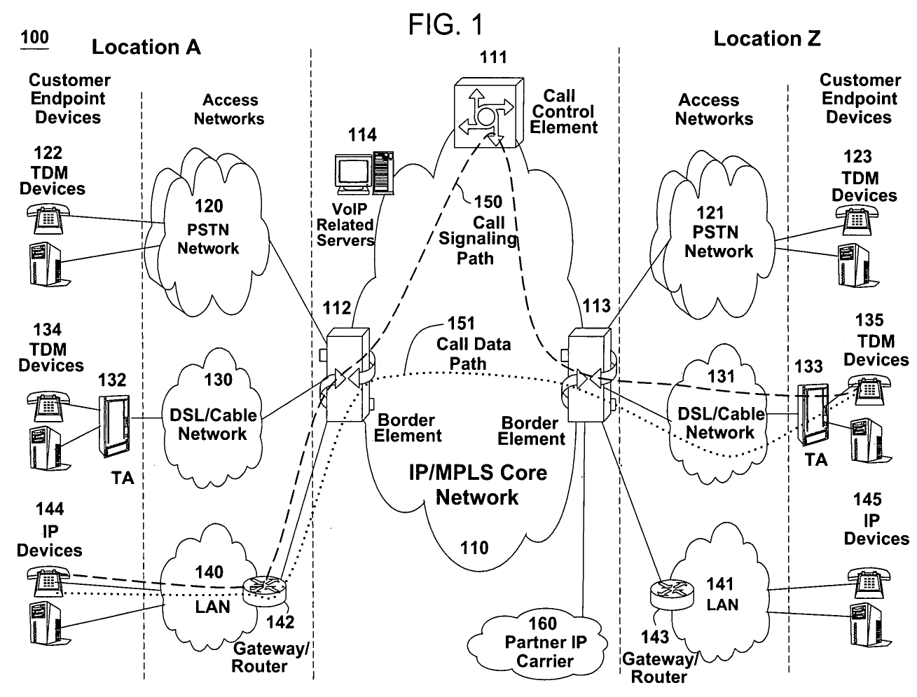

To better understand the present invention, FIG. 1 illustrates an example network, e.g., a packet-switched network such as a VoIP network related to the present invention. The VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. An IP network is broadly defined as a network that uses Internet Protocol to exchange data packets.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

As VoIP services grow, users of VoIP networks will communicate with other users of the VoIP network. Similar to users of instant messaging, the VoIP network users may wish to use a personalized name or identity when communicating with other users.

To address this need, the present invention enables registered VoIP subscribers to register their preferred identity or name with a VoIP network service. This registered name will then be forwarded in the calling name field of the call setup message when these users signal to the network that they want to place a call to another network user.

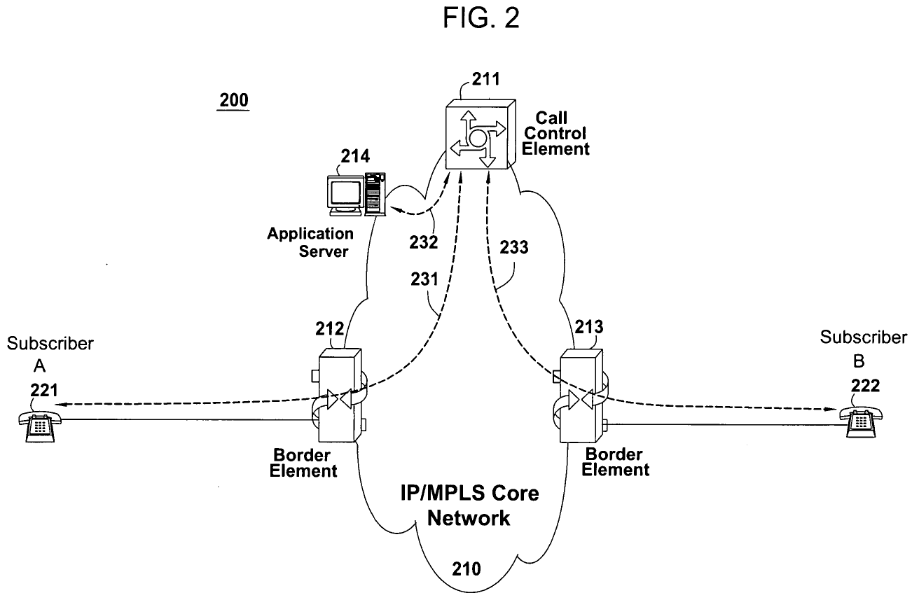

FIG. 2 illustrates an example of enabling personalized name identification in the calling name field in VoIP services. Subscriber A, 221, is a subscriber of VoIP services in network 200. Subscriber A also has signed up and registered for the personalized name identification in the calling name field service feature. The registration of the personalized identification string is performed either through a telephone interface with a customer care agent or via a website interface. Subscriber A places a call to subscriber B, 222. CCE 211 receives a call setup message 231 from subscriber A. CCE 211 performs a lookup 232 of the type of services that the calling party A has subscribed and finds out that subscriber A has registered for the personalized name identification in the calling name field service feature. The registered name ID string is retrieved from the Application Server (AS) 214. Then CCE 211 continues to process the call setup message 233 by inserting the registered name ID string of subscriber A in the calling name field of the call setup message. CCE 211 then sends the call setup message to subscriber B, the called party, to complete the call setup. Note that this service feature applies to both VoIP and PSTN called party endpoints.

In one embodiment, the personalized identification string can be any combinations of characters and/or numbers as desired by the subscribers. As such, in one embodiment, the personalized identification string is not the real name of the subscribers. As such, the present invention is a service feature that provides anonymity and/or identification flexibility to the calling party.

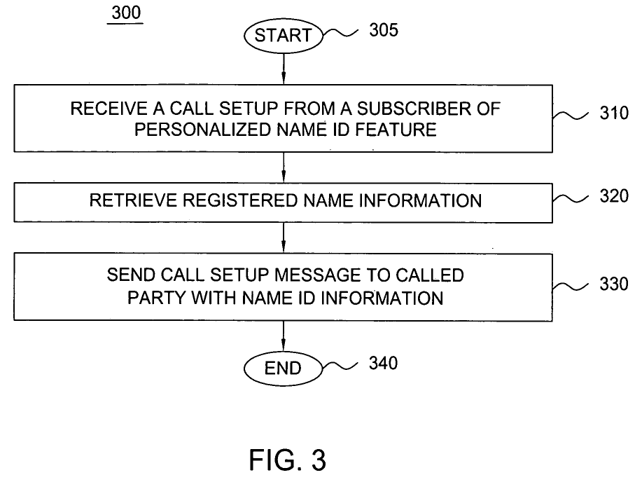

FIG. 3 illustrates a flowchart of a method for enabling personalized identification in the calling name field in packet-switched services, e.g., VoIP services. In one embodiment, the method is executed by the CCE. Method 300 starts in step 305 and proceeds to step 310.

In step 310, the method receives a call setup message (e.g., a Session Initiation Protocol (SIP) signaling message) from a subscriber of VoIP services. In one embodiment, the VoIP service is the personalized name identification in the calling name field service.

In step 320, the method finds out that the subscriber also has signed up for the personalized name identification in the calling name field service feature and retrieves the registered personalized name ID string from the Application Server (AS). In one embodiment, the CCE acquires this information from the AS.

In step 330, the method inserts the registered personalized name ID string in the calling name field of the call setup message and then sends the message to the called party to complete the call setup procedures. The method ends in step 340.

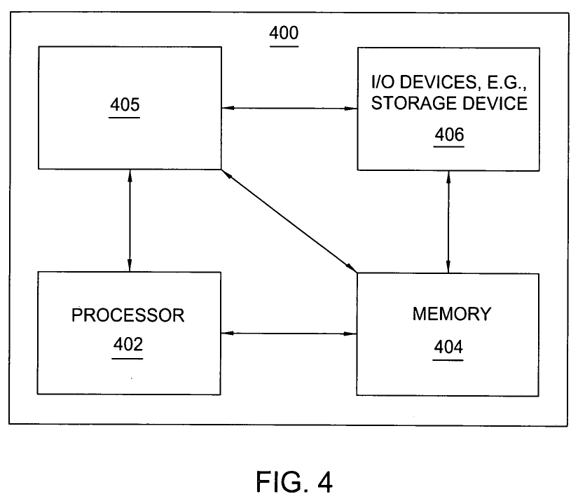

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a personalized calling name identification module 405, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present personalized calling name identification module or process 405 can be loaded into memory 404 and executed by processor 402 to implement the functions as discussed above. As such, the present personalized calling name identification process 405 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing personalized identification in a communication network, comprising:
receiving a call setup message from a subscriber;
determining whether said subscriber has registered a personalized identification string; and
inserting said personalized identification string in a calling name field of said call setup message.

2. The method of claim 1, wherein said communication network is a Voice over Internet Protocol (VoIP) network.

3. The method of claim 1, wherein said personalized identification string is registered via a telephone interface or a website interface by said subscriber.

4. The method of claim 1, wherein said personalized identification string is inserted into said calling name field of said call setup message by a call control element (CCE).

5. The method of claim 4, wherein said personalized identification string is retrieved by said CCE from an Application Server (AS).

6. The method of claim 1, wherein said call setup message is a Session Initiation Protocol (SIP) signaling message.

7. The method of claim 1, wherein said call setup message is used to complete a call originated by said subscriber to a VoIP endpoint or to a Public Switched Telephone Network endpoint.

8. The method of claim 1, further comprising:
registering said personalized identification string by said user.

9. A computer-readable medium having stored thereon a plurality of instructions, the plurality of instructions including instructions which, when executed by a processor, cause the processor to perform the steps of a method for providing personalized identification in a communication network, comprising:
receiving a call setup message from a subscriber;
determining whether said subscriber has registered a personalized identification string; and
inserting said personalized identification string in a calling name field of said call setup message.

10. The computer-readable medium of claim 9, wherein said communication network is a Voice over Internet Protocol (VoIP) network.

11. The computer-readable medium of claim 9, wherein said personalized identification string is registered via a telephone interface or a website interface by said subscriber.

12. The computer-readable medium of claim 9, wherein said personalized identification string is inserted into said calling name field of said call setup message by a call control element (CCE).

13. The computer-readable medium of claim 12, wherein said personalized identification string is retrieved by said CCE from an Application Server (AS).

14. The computer-readable medium of claim 9, wherein said call setup message is a Session Initiation Protocol (SIP) signaling message.

15. The computer-readable medium of claim 9, wherein said call setup message is used to complete a call originated by said subscriber to a VoIP endpoint or to a Public Switched Telephone Network endpoint.

16. The computer-readable medium of claim 9, further comprising:
registering said personalized identification string by said user.

17. An system for providing personalized identification in a communication network, comprising:
means for receiving a call setup message from a subscriber;
means for determining whether said subscriber has registered a personalized identification string; and
means for inserting said personalized identification string in a calling name field of said call setup message.

18. The system of claim 17, wherein said communication network is a Voice over Internet Protocol (VoIP) network.

19. The system of claim 17, wherein said personalized identification string is registered via a telephone interface or a website interface by said subscriber.

20. The system of claim 17, further comprising:
means for registering said personalized identification string by said user.
